(19) United States
(12) Patent Application Publication
(10) Pub. No.: US 2007/0095367 A1
(43) Pub. Date: May 3, 2007

(54) Apparatus and method for atomic layer cleaning and polishing

(76) Inventors: Yaxin Wang, Fremont, CA (US); Fang Mei, Foster City, CA (US); Van H. Nguyen, Milpitas, CA (US); Arulkumar Shanmugasundram, Sunnyvale, CA (US); Dmitry Lubomirsky, Cupertino, CA (US)

Correspondence Address: PATTERSON & SHERIDAN, LLP, 3040 POST OAK BOULEVARD, SUITE 1500, HOUSTON, TX, 77056, US

(21) Appl. No.: 11/262,445

(22) Filed: Oct. 28, 2005

(51) Int. Cl. B08B 7/04; B08B 3/00; B08B 7/00

(52) U.S. Cl. 134/33; 134/149; 134/137; 134/94.1; 134/18

(57) ABSTRACT

The present invention generally provides an apparatus and method of processing substrates to uniformly remove any residual contamination from the surface of a substrate by use of an appropriate cleaning chemistry and contact with a cleaning medium. In one embodiment, the cleaning medium, such as is a brush or a scrubbing component that is positioned in a cleaning module. In one embodiment, the process of cleaning the surface of a substrate W is completed by “scrubbing” the surface of the substrate while using a cleaning solution that is selected to chemically etch a material from the surface of the substrate. In one aspect, the amount of material removed from the surface of a substrate is only about 10-30 Angstroms (Å). In one embodiment, the substrate surface is cleaned by use of a scrubbing process that uses a fluid that doesn't react with the exposed materials on the surface of the substrate. The fluid is thus used to lubricate the surfaces in contact and to carry any abraded material away from the surface of the substrate. In one aspect, the fluid may be DI water. In one aspect, it may be desirable to add ultrasonic or megasonic agitation to the substrate during the cleaning process to help remove or dislodge material from the surface of the substrate.

### BACKGROUND OF THE INVENTION

1. Field of the Invention

Embodiments of the present invention are generally concerned with apparatuses for cleaning thin substrates such as semiconductor wafers, compact discs, flat panel displays and the like. More particularly, the invention is concerned with brush apparatuses for cleaning a substrate.

2. Description of the Related Art

The push in the semiconductor industry to shrink the size of semiconductor devices to improve device processing speed and reduce the generation of heat by the formed device, has caused the industry to reduce the size and geometry of the features formed on the surface of the substrate and reduce the tolerance to process variability from substrate to substrate. Due to the shrinking size of semiconductor devices and the ever increasing device performance requirements, the allowable variability of the device fabrication process uniformity and repeatability has greatly decreased.

One important aspect of formed semiconductor devices are the electrical interconnects that are formed between the various levels of the device, which include contacts, vias, trenches, lines and other features. Reliable and repeatable formation of these interconnects is very important to the formation of ultra-large scale integration (ULSI) type devices and to the continued effort to increase circuit density by decreasing the dimensions of semiconductor features and decreasing the widths of interconnects (e.g., lines) to 0.13 μm and less. Currently, copper and its alloys have become the metals of choice for sub-micron interconnect technology because copper (Cu) has a lower resistivity than aluminum (Al) (i.e., 1.67 μΩ-cm for Cu as compared to 3.1 μΩ-cm for Al), a higher current carrying capacity, and significantly higher electromigration resistance.

However, despite the positive attributes of Cu, Cu interconnects are susceptible to copper diffusion, electromigration related failures, and oxidation related failures. Typically, a liner barrier layer is used to encapsulate the sides and bottom of the Cu interconnect to prevent diffusion of Cu to the adjacent dielectric layers. The oxidation and electromigration related failures of Cu interconnects can be significantly reduced by depositing a thin metal capping layer of, for example, cobalt tungsten phosphorus (CoWP), cobalt tin phosphorus (CoSnP), or cobalt tungsten phosphorus boron (CoWPB), onto the surface of the Cu interconnect formed after a chemical mechanical planarization (CMP) process has been performed. In addition, to increase adhesion and selectivity of the deposited capping layer over the Cu interconnect, an activation layer such as palladium (Pd) or platinum (Pt) may be deposited on the surface of the Cu interconnection prior to depositing the capping layer. It is envisioned in the 65 nanometer device fabrication process that the thickness of the capping layer will at most be about 50 to about 400 angstroms (Å) thick to form a reliable barrier to diffusion, but also reduce the resistance of the metal stack formed containing the capping layer.

Due to the size and density of the devices formed on a substrate it has become especially important to prevent electrical shorts or other device defects caused by surface contamination or other residue left-over from the capping layer process and/or other prior processes (e.g., CMP). It is common to require various cleaning and/or scrubbing process steps be performed on the surface of a substrate to remove the unwanted surface contamination. Due to the need to reduce line resistance, the capping layers are purposely made rather thin. Thus the use of a purely chemical etching type process is not generally effective since these processes are relatively unselective and will remove a significant portion of the formed capping layer in the process of removing the surface contamination.

Conventional scrubbing techniques are not effective since the removal rate of these conventional processes are too fast given the size of the deposited layer thus making it hard to control the cleaning process. Also, conventional brush or abrasive removal processes tend to remove a non-uniform amount of material from the center to the edge of the substrate which is not acceptable given how thin the capping layer is as deposited. The issue has not been a problem in the convention cleaning processes due to the amount of material removed in the conventional substrate cleaning process step(s) used in other applications, since the amount of material removed by the cleaning process is usually negligible compared to the material removed in the prior processes or the amount of material left over. Therefore, since the layers deposited in most capping processes is small, for example 10 to 100 angstroms, any material removed non-uniformly in the scrubbing process will greatly affect the uniformity of the capping thickness from the center to the edge of the substrate and the capping layer effectiveness as a barrier.

Therefore, there is a need for a apparatus and method of removing surface contamination from the surface of a substrate without impacting the thickness uniformity of thin films deposited on a substrate.

### SUMMARY OF THE INVENTION

The present invention generally provide a substrate cleaning chamber that is adapted to clean a surface of a substrate, comprising a roller that is adapted to rotate a substrate, wherein an axis of rotation of the substrate is generally perpendicular to a processing surface of the substrate, a cleaning medium having a surface that has a non-uniform profile, wherein the cleaning medium is adapted to provide a non-uniform force along the radius of the processing surface of the substrate, and a motor that is adapted to rotate the cleaning medium, wherein the axis of rotation of the cleaning medium is generally perpendicular to the axis of rotation of the substrate.

Embodiments of the invention may further provide a substrate cleaning chamber that is adapted to clean a surface of a substrate, comprising a roller that is adapted to rotate a substrate, wherein an axis of rotation of the substrate is generally perpendicular to a processing surface of the substrate positioned on the roller, a cleaning medium having a surface that has a non-uniform profile, wherein the cleaning medium comprises a first cleaning medium that is adapted to clean a surface of a substrate, and a second cleaning medium that is adapted to clean a surface of a substrate, wherein the first cleaning medium has a different material property than the second cleaning medium, and a motor that is adapted to rotate the cleaning medium, wherein the axis of rotation of the cleaning medium is generally perpendicular to the axis of rotation of the substrate.

Embodiments of the invention may further provide a substrate cleaning chamber that is adapted to clean a surface of a substrate, comprising a roller that is adapted to rotate a substrate, wherein an axis of rotation of the substrate is generally perpendicular to a processing surface of the substrate positioned on the roller, a brush assembly comprising a cleaning medium having a surface that has a non-uniform profile, wherein the cleaning medium is adapted to provide a non-uniform force along the radius of the processing surface of the substrate, and two or more sensors that are coupled to the cleaning medium and are adapted to sense the force applied in different regions of the processing surface of the substrate by the cleaning medium, and a motor that is adapted to rotate the cleaning medium, wherein the axis of rotation of the cleaning medium is generally perpendicular to the axis of rotation of the substrate, an actuator coupled to the brush assembly that is adapted to supply a adjustable force to urge the cleaning medium against the processing surface of the substrate, and a controller adapted to control the force supplied to the cleaning medium by the actuator based on input received from the two or more sensors.

Embodiments of the invention may further provide a method of cleaning a processing surface of a substrate, comprising rotating a substrate at a first rotational speed about an axis that is generally perpendicular to a processing surface of the substrate, rotating a cleaning medium that has a non-uniform surface profile at a second rotational speed about an axis that is generally perpendicular to the axis of rotation of the substrate, and urging the cleaning medium having a non-uniform profile against the processing surface of a substrate by use of an actuator, wherein the cleaning medium is adapted to provide a non-uniform force along the radius of the processing surface of the substrate.

Embodiments of the invention may further provide a method of cleaning a processing surface of a substrate, comprising rotating a substrate at a first rotational speed about an axis that is generally perpendicular to a processing surface of the substrate, rotating a cleaning medium that has a non-uniform surface profile at a second rotational speed about an axis that is generally perpendicular to the axis of rotation of the substrate, wherein non-uniform surface profile of the cleaning medium has a central region and an edge region, positioning the substrate so that a point on the processing surface of the substrate through which the axis of rotation passes contacts a point in the central region of the non-uniform profile, and urging the cleaning medium having a non-uniform profile against the processing surface of a substrate by use of an actuator, wherein the cleaning medium is adapted to provide a non-uniform force along the radius of the processing surface of the substrate.

Embodiments of the invention may further provide a method of cleaning a processing surface of a substrate, comprising rotating a substrate at a first rotational speed about an axis that is generally perpendicular to a processing surface of the substrate, rotating a cleaning medium that has a non-uniform surface profile at a second rotational speed about an axis that is generally perpendicular to the axis of rotation of the substrate, urging the cleaning medium having a non-uniform profile against the processing surface of a substrate by use of an actuator, wherein the actuator and cleaning medium are adapted to provide a non-uniform force along the radius of the processing surface of the substrate, measuring the force applied to the processing surface of the substrate by the cleaning medium by use of a plurality of sensors coupled to the cleaning medium, and collecting the measured force from the plurality of sensors and adjusting the force delivered to the processing surface by the cleaning medium by use of a controller that is adapted to control the force supplied by the actuator.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a cross-sectional view of a scrubbing device that may be adapted to perform an embodiment described herein;

FIG. 2 illustrates a cross-sectional view of a scrubbing device that may be adapted to perform an embodiment described herein;

FIG. 3 illustrates a top cross-sectional view of a scrubbing device that may be adapted to perform an embodiment described herein;

FIG. 3A illustrates a top cross-sectional view of a brush assembly that may be adapted to perform an embodiment described herein;

FIG. 4 illustrates a process sequence according to one embodiment described herein;

FIG. 5 illustrates a top cross-sectional view of a scrubbing device that may be adapted to perform an embodiment described herein;

FIG. 6 illustrates top a cross-sectional view of a scrubbing device shown in FIG. 5 where the brush assemblies have been placed in contact with a substrate;

FIG. 7 illustrates a cross-sectional views of a brush assembly that has a desired surface profile which may be adapted to perform an embodiment described herein;

FIG. 8 illustrates a cross-sectional views of a brush assembly that has a desired surface profile which may be adapted to perform an embodiment described herein;

FIG. 9 illustrates a cross-sectional views of a brush assembly that has a desired surface profile which may be adapted to perform an embodiment described herein;

FIG. 10 illustrates a cross-sectional views of a brush assembly that has a desired surface profile which may be adapted to perform an embodiment described herein;

FIG. 11 illustrates a cross-sectional views of a brush assembly that has a desired surface profile which may be adapted to perform an embodiment described herein;

FIG. 12 illustrates a cross-sectional views of a brush assembly that has a desired surface profile which may be adapted to perform an embodiment described herein;

FIG. 13 illustrates a plan view of the processing surface of a substrate illustrating an example of a shape of the contact surface area 120 created by the brush assembly illustrated in FIG. 7;

FIG. 14 illustrates a plan view of the processing surface of a substrate illustrating an example of a shape of the contact surface area 120 created by the brush assembly illustrated in FIG. 8;

FIG. 15 illustrates a plan view of the processing surface of a substrate illustrating an example of a shape of the contact surface area 120 created by the brush assembly illustrated in FIG. 9;

FIG. 16 illustrates a plan view of the processing surface of a substrate illustrating an example of a shape of the contact surface area 120 created by a brush assembly;

FIG. 17 illustrates a cross-sectional view of a brush assembly that may be adapted to perform an embodiment described herein.

### DETAILED DESCRIPTION

The present invention generally provides an apparatus and method of processing substrates to uniformly remove any residual contamination on the surface of a substrate by use of an appropriate cleaning chemistry and contact with a cleaning medium. In one embodiment, the cleaning medium is a brush or a scrubbing component that is positioned in a cleaning module in a cluster tool. In general the apparatus and method described herein is especially useful after performing an electroless and/or electrochemical plating process on the substrate. An example of an exemplary electroless plating cluster tool that may be useful to perform aspects of the invention described herein is further described in U.S. patent application Ser. No. 11/043,442, filed Jan. 26, 2005, which is incorporated by reference herein in its entirety to the extent not inconsistent with the claimed aspects and description herein.

In one embodiment, the process of cleaning the surface of a substrate W is completed by “scrubbing” the surface of the substrate while using a cleaning solution that is selected to chemically etch a material from the surface of the substrate. The terms “scrub”, “scrubbing”, “abrade” and/or abrading” as used herein is intended to describe the process of contacting the surface of the substrate with a cleaning medium (e.g., element 14 of the brushes 13a and 13b discussed below) to cause material that is in contact with the surface, embedded in the surface, or deposited on the surface of the substrate to be uniformly removed by friction created between the cleaning medium and the substrate surface. In one aspect, the amount of material removed from the surface of a substrate is only about 10-30 Angstroms (Å) and thus the uniformity with which the material is removed from the substrate surface is important.

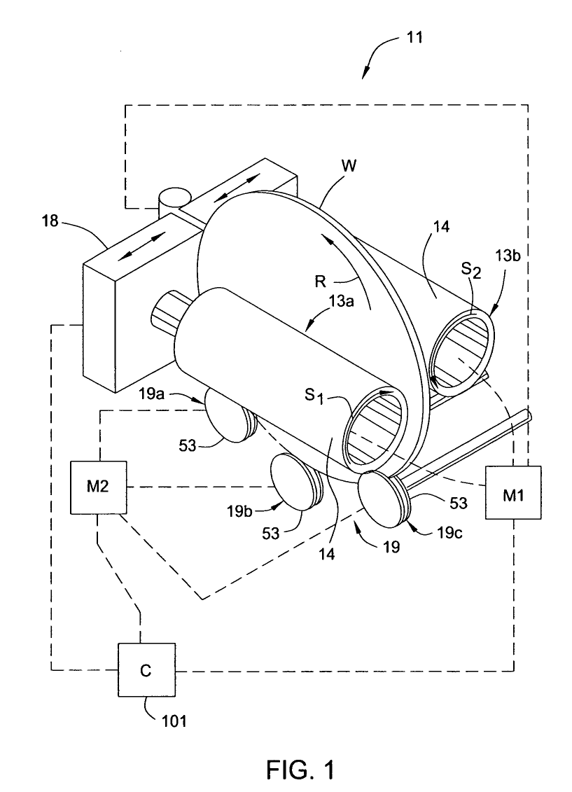

In one embodiment, the substrate surface is cleaned by use of a scrubbing process that uses a fluid that doesn't react with the exposed materials on the surface of the substrate. The fluid is thus used to lubricate the substrate and cleaning medium surfaces and to carry any abraded material away from the surface of the substrate. In one aspect, the fluid may be DI water. In one aspect, it may be desirable to add ultrasonic or megasonic agitation to the substrate through the brushes (elements 13a or 13b in FIG. 1-5) or dispensed fluid during the cleaning process to help remove or dislodge material from the surface of the substrate.

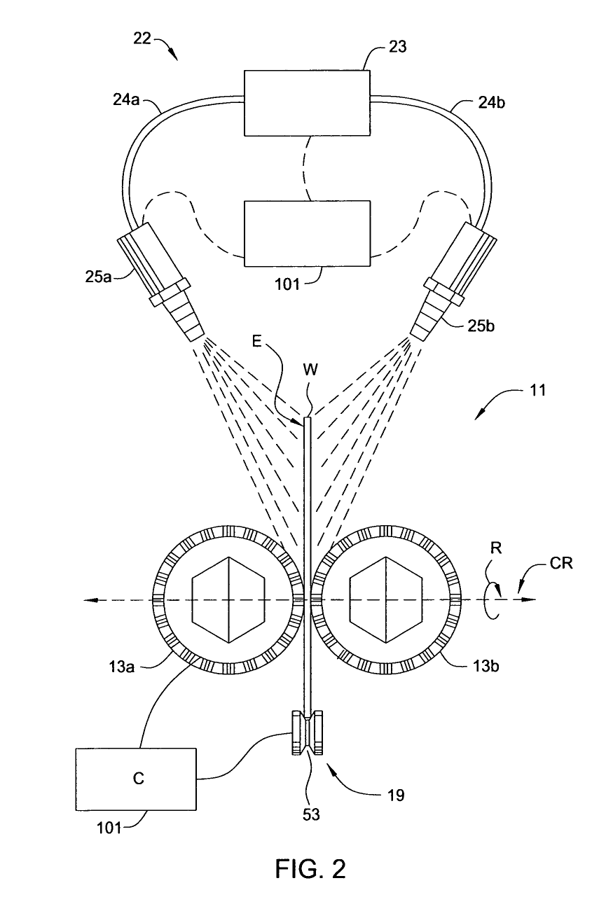

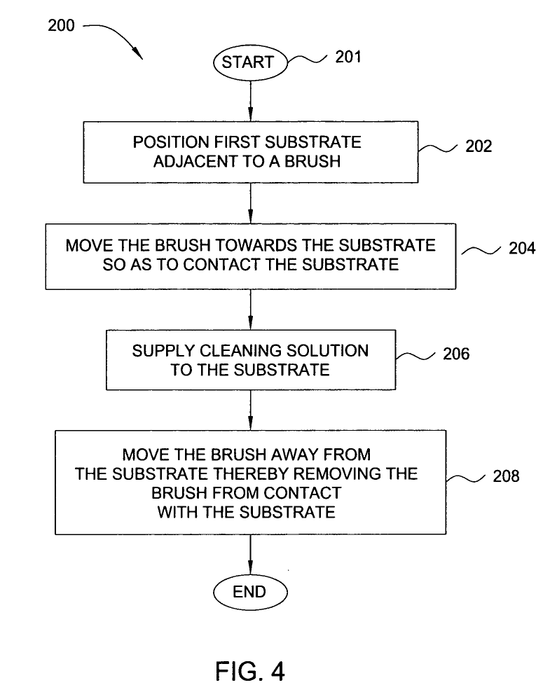

FIG. 1 is a side perspective view of a scrubbing device 11 that may perform a scrubbing process 200 discussed below in conjunction with FIG. 4. The scrubbing device 11 generally comprises a pair of brushes 13a, 13b and a substrate support assembly 19. The cleaning medium 14 of the brushes 13a and 13b (FIGS. 1-2) as shown have a uniform profile, or shape, and are positioned so that the contacting region generally extends through the center of the substrate. The term “uniform profile” is generally meant to describe the substrate contacting surface of the cleaning medium 14 that is uniform in shape across its length and thus has a generally flat surface. It should be noted that the term “uniform profile” can also be describe a cleaning medium surface that has a number of protrusions, bumps or ridges formed thereon which when averaged over time due to the rotation of the cleaning medium relative to the substrate surface would deliver a uniform time averaged contact of the substrate surface. The term “profile”, as used herein, is generally intended to described the macroscopic time averaged shape of the substrate contacting surface of the cleaning medium 14. The removal rate of material from the surface of a substrate when using a cleaning medium that has a uniform profile and has uniform material properties throughout the cleaning medium will not deliver a uniform material removal rate from center to edge of the substrate.

It should be noted that important cleaning medium material properties may include, for example, the cleaning medium material's compressive modulus, the structural stiffness of the cleaning medium and support assembly, and the kinetic friction coefficient. The kinetic friction coefficient is typically a constant across the surface of the cleaning medium that is in contact with the substrate for most conventional designs. It is believed that the non-uniform removal rate is due to the uneven amount work done on the substrate surface by the cleaning medium as a function of the substrate radius when a cleaning medium having a uniform profile and having uniform cleaning medium material properties is used. Work is generally defined as force times distance (i.e., W=F×d). The force, which is a friction force, is proportional to the normal force applied by the cleaning medium times the kinetic friction coefficient created between the cleaning medium and the processing surface of the substrate. The distance is a measure of the length of contact of any point on the cleaning medium along the substrate surface.

Therefore, in one embodiment of the invention it is desirable to shape the surface of the cleaning medium to significantly improve the material removal rate across the surface of the substrate during the scrubbing process by varying the contact area and/or force applied to the substrate along a radius, diameter or cord of the substrate. In another aspect, it is desirable to vary the material properties of the cleaning medium to achieve a desired material removal rate across the substrate surface. Typical material properties that may be varied include, but are not limited to the structural stiffness of sections of the material (e.g., related to shape and cross-section of components), bulk material properties (e.g., surface hardness, density of bulk material(s)), and surface properties (e.g., kinetic coefficient of friction). Since one of the aspects of the invention is to provide a scrubbing device 11 that can uniformly remove only about tens of angstroms of material from the surface of the substrate the non-uniform removal rates commonly allowed in conventional processes is generally not acceptable. While FIGS. 1-3, 5-12 and 17, illustrate a cleaning medium that has a surface that doesn't contain a number of protrusions, bumps or ridges formed thereon, this configuration is not intended to be limiting as to the scope of the invention, since one skilled in the art will appreciate that a surface having these features could be configured such that the time averaged contact, due to the rotation of the cleaning medium relative to the substrate surface, could be configured to deliver a uniform material removal rate.

In one aspect, the brushes 13a, 13b are supported by a pivotal mounting system (e.g., position actuator assembly 18) adapted to move the brushes 13a, 13b into and out of contact with the substrate W that is supported by the substrate support assembly 19, thus allowing the brushes 13a, 13b to move between closed and open positions to allow a substrate W to be extracted from and inserted therebetween as described below. A first motor M1 is coupled to the brushes 13a, 13b and adapted to rotate the brushes 13a, 13b.

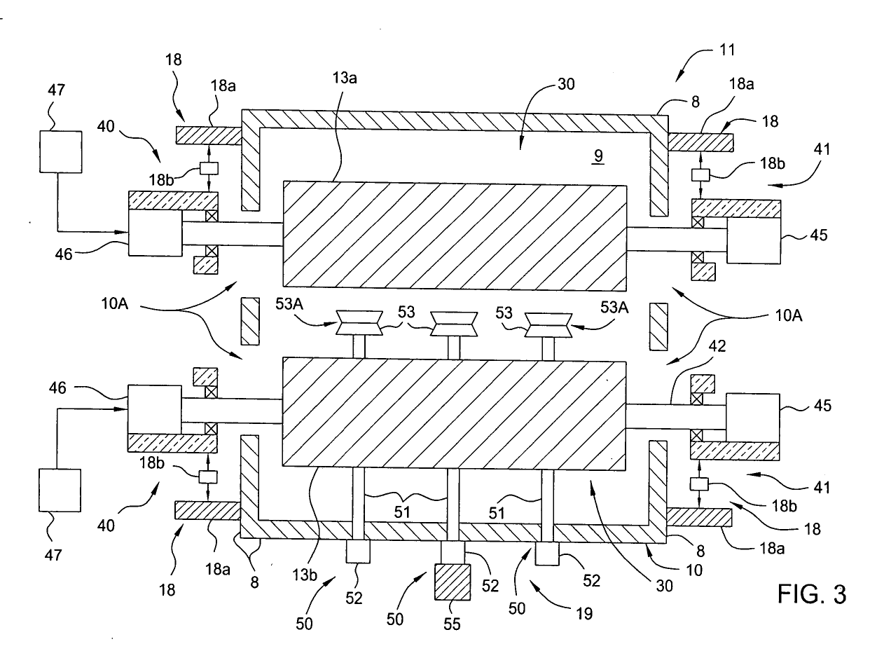

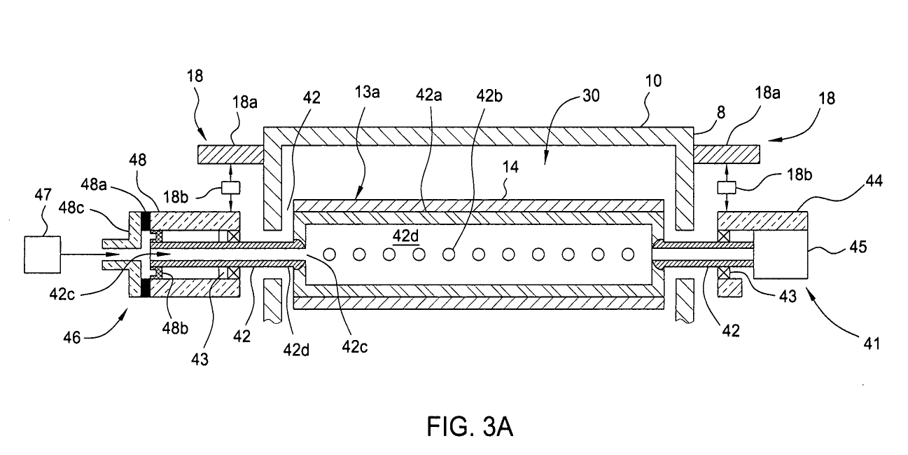

The scrubber device 11 also has a substrate support assembly 19 adapted to support and rotate a substrate W (see element “R” in FIG. 1) during processing. In one aspect, the substrate support assembly 19 may comprise a plurality of rollers 19a-c each having a groove 53A (FIG. 3) adapted to support the substrate W vertically. A second motor M2 is coupled to the rollers 53 contained in the roller assemblies 50 and is adapted to rotate at least one of the rollers 53 and a substrate positioned thereon.

In one aspect, a controller 101 is adapted to control the various components in the scrubber device 11, such as the first motor M1, the second motor M2, the substrate support assembly 19, and the position actuator assembly 18. The controller 101 is generally adapted to control the various scrubber device 11 components and process variables during the completion of a scrubbing process. The processing chamber's processing variables may be controlled by use of the controller 101, which is typically a microprocessor-based controller. The controller 101 is configured to receive inputs from a user and/or various sensors in the scrubber device 11 and appropriately control the scrubber device components in accordance with the various inputs and software instructions retained in the controller's memory. The controller 101 generally contains memory and a CPU which are utilized by the controller to retain various programs, process the programs, and execute the programs when necessary. The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like all well known in the art. A program (or computer instructions) readable by the controller 101 determines which tasks are performable in the scrubber device 11. Preferably, the program is software readable by the controller 101 and includes instructions to monitor and control the scrubbing process based on defined rules and input data.

FIG. 2 illustrates a side schematic view of the scrubber device 11 illustrated in FIG. 1 that has been adapted to support a wafer in a vertical orientation, and contains a fluid delivery system 22. One will note that while FIGS. 1 and 2 illustrate a scrubber device 11 that has two brushes 13a and 13b which each have a cleaning medium 14 that contacts the front and backside of the substrate W to “scrub” the substrate W surface, other embodiments of the invention may be adapted to only “scrub” the front surface of the substrate, without varying from the basic scope of the invention described herein. Also, the scrubber device 11 may support a substrate W in orientations other than vertical without varying from the basic scope of the invention. While FIGS. 1-3 and FIGS. 5-12, illustrate a cleaning medium that is generally cylindrical in shape, other shapes may be used without varying from the basic scope of the invention.

In the configuration shown in FIG. 2 the substrate W is supported by a plurality of rollers 53 and the pair of brushes 13a, 13b. The rollers 53 (only one shown), which may be configured to support the substrate W vertically with minimal contact, are adapted to rotate the substrate W. An exemplary version of an automated scrubber device 11 is disclosed in U.S. patent application Ser. No. 09/191,061 [AMAT 2733] entitled Method and Apparatus For Cleaning The Edge Of A Thin Disc, filed on Nov. 11, 1998, the entire disclosure of which is incorporated herein by this reference.

In one embodiment, the scrubber device 11 also may include a plurality of liquid supply lines 24a-b that are adapted to carry liquid from a fluid source 23 to the spray nozzles 25a-b positioned in the scrubber device 11. In one aspect, a controller 101 is adapted to control the composition of the liquid delivered from the fluid source 23 and/or the position of at which the spray nozzles 25a-b are positioned relative to the substrate W by use of an conventional actuator (not shown). The backside spray nozzle 25b and frontside spray nozzle 25a are positioned to deliver a cleaning solution to the various surfaces of the substrate. In one embodiment, the fluid source 23 is adapted to deliver a cleaning solution to the substrate W from the backside spray nozzle 25b via the liquid supply line 24b and/or from the frontside nozzle 25a via the liquid supply line 24a. In one aspect, the fluid source 23 is also adapted to deliver DI water, or other non-cleaning solutions to the substrate as desired. In one aspect, the fluid source 23 is adapted to deliver an etching solution to the frontside nozzle 25a while a non-cleaning solution, such as DI water is delivered to the backside nozzle 25b. In another aspect, the fluid source 23 is adapted to deliver an etching solution to the backside nozzle 25b while a non-cleaning solution, such as DI water is delivered to the frontside nozzle 25a. The scrubbing device 11 may further comprise a plurality of spray nozzles coupled to a source 23. The spray nozzles may be positioned to spray a fluid (e.g., deionized water, SC1, dilute hydrofluoric acid, Electraclean, or any other liquid solution used for cleaning) at the surfaces of the substrate W or at the brushes 13a, 13b during wafer scrubbing. Alternatively or additionally fluid may be supplied through the brushes themselves as is conventionally known.

In one embodiment, the frontside nozzle 25a is positioned to deliver a tailored non-uniform flow (e.g., higher flow) of an etching solution to various regions of the processing surface of the substrate during the scrubbing process 200. This configuration may be useful when the chemical concentrations are diluted to improve the ability to control the etch rate when only removing small amounts of material (discussed below), since the etch rate is dependent on the boundary layer thickness and thus the impinging flow. The etch rate when using dilute concentrations is believed to be limited by the ability of the etching components to contact with the surface of the substrate, which is helped by reducing the boundary layer thickness. In one aspect, it may be desirable to orient the frontside nozzle 25a so that there is a higher flow rate of the etching solution near the substrate edge “E”, such that the etch rate is higher near the edge than near the center of the substrate.

FIG. 3 illustrates a top cross-sectional view of a scrubber device 11 having two brushes 13a and 13b and a substrate support assemblies 19 which are similar to the embodiments shown in FIGS. 1-2. The configuration shown in FIG. 3 contains two brush assemblies 30, a chamber 10, and a substrate support assembly 19. The chamber 10 is generally an enclosure having one or more walls 8 that enclose and form a processing region 9 in which the scrubbing process 200 (described below) is preformed. In general the walls 8 may be made of plastic (e.g., polypropylene (PP), polyethylene (PE)) or coated metal (e.g., aluminum with an ETFE coating) that will not be attacked by the chemistry used during the cleaning process and provide structural support to the various components found in the scrubber device 11.

The substrate support assembly 19 will generally contain two or more roller assemblies 50 that are adapted to support the substrate. In the configuration shown in FIG. 3, the substrate support assembly 19 has three rollers assemblies 50. Each roller assembly 50, which is may be mounted on one of the walls 8 of the chamber 10, generally contains a rotation assembly 52, a shaft 51 and a roller 53. The rotation assembly 52 generally contains various bushings, bearings or other conventional rotatable support components that can be adapted to support the weight of various components in the roller assembly 50 and the substrate W during processing. In one aspect, at least one of the roller assemblies 50 in the substrate support assembly 19 also contains a motor 55 that is adapted to rotate the shaft 51, roller 53 and substrate positioned thereon during processing. In this configuration, the roller assemblies 50 that do not contain a motor are passive elements that are used to support the substrate.

FIG. 3A illustrates a horizontal cross-sectional view of one half of the scrubbing device 11 that is formed by a cross-sectional plane that passes through the center of brush 13a shown in FIG. 3. Referring to FIG. 3A, the brush assembly 30 generally contains a cleaning medium 14, a support shaft 42, a rotation assembly 41, a position actuator assembly 18, and an optional fluid feed-through assembly 40. The cleaning medium 14 is retained on the support shaft 42 which are rotated by use of the rotation assembly 41. In one embodiment, the brush assembly 30, which is generally positioned in the processing region 9, is connected to the rotation assembly 41 by the support shaft 42 that extends through the openings 10A formed in the walls 8. The support shaft 42 is generally a structural elements made from a material, such as a stainless steel, hastalloy C, plastic materials (e.g., polyvinylidene difluoride (PVDF), polypropylene (PP)), or other suitable material, that is able to support the cleaning medium 14 and loads applied to it as the position actuator assembly 18 urges the cleaning medium 14 against the surface of the substrate during the scrubbing process 200 (discussed below). The rotation assembly 41 generally contains an actuator 45, bearing 43 and support plate 44, which are adapted to support and rotate the support shaft 42 during the cleaning process. The actuator 45 may be a direct drive stepper motor or DC servomotor assembly (not shown) that is adapted to drive the support shaft 42. In one aspect, the actuator 45 is a motor (not shown) that is coupled to a gear and pulley system which drives the support shaft 42 during processing.

The optional feed-through assembly 40 generally contains a feed-through 46, which is a conventional rotating fluid feed-through (e.g., lip seal design), that is adapted to deliver a fluid from a fluid source 47 to an interior regions 42c and 42d of the support shaft 42 so that the fluid can be transferred from the center region 42d through the cleaning medium 14 to the surface of the substrate. When in use the feed-through 46 receives a fluid from the fluid source 47 and delivers the fluid to the center region 42d of a support shaft 42 through the inlet region 42c in the support shaft 42. The fluid in the center region 42d then passes through a plurality of holes 42b formed in the cleaning medium support 42a, through the cleaning medium 14 to the surface of a substrate (not shown) that is in contact with the cleaning medium 14. In general the feed-through 46 generally contains a rotary lip seal 48b, a support frame 48, an inlet port 48c and an inlet port seal 48a that form a rotary seal that can deliver fluids to the cleaning medium 14 while the actuator 45 is rotating the brush assembly 30 components. In one aspect, it may be desirable to vary the size of the plurality of holes 42b formed in the cleaning medium support 42a (FIG. 3A) to vary the flow rate of the chemicals passed through the cleaning medium 14.

The position actuator assembly 18 is adapted to position the brush assembly 30 in a desired position in the processing chamber and apply a repeatable force to the brush assembly 30 as the cleaning medium 14 is urged against substrate surface. In one aspect, the position actuator 18 contains a guiding assembly (not shown; e.g., ball slide, linear slide), a mounting bracket 18a and an actuator 18b that is adapted to position the brush assembly 30. In one aspect, the actuator 18b may be a pneumatic air cylinder, or a lead screw that is attached to a motor, that is adapted to position the brush assembly 30 and apply a repeatable force to the rotation assembly 41. In general the position actuator assembly 18 is designed to evenly distribute the load applied force to the substrate. An exemplary method and apparatus to evenly applying force to a substrate and connect the various components (e.g., brush assembly 30, position actuator assembly 18) is further described in the commonly assigned U.S. Pat. No. 6,820,298, filed Apr. 19, 2001, which is incorporated by reference herein in its entirety to the extent not inconsistent with the claimed aspects and description herein.

Scrubbing Process

FIG. 4 illustrates a flowchart of an inventive scrubbing process 200 that may be performed in the scrubber device 11, described above. Referring to FIGS. 1-4, the inventive scrubbing process 200 starts at step 201. In one embodiment, the inventive scrubbing process 200 may operate according to the following process. The brushes 13a, 13b are initially in an open position (not shown), which requires that the brushes be a sufficient distance from each other so as to allow a substrate W to be inserted therebetween. The initial rotational rate of the brushes 13a, 13b may be configured as desired by use of a controller 101 and motor M1. For example, the initial rotational rate of the brushes 13a, 13b may be either zero, a slow rate (e.g., 120 rpm), or a first rate (e.g., 400 rpm). In one aspect, the rotation speed of the brushes 13a, 13b is about 3 to about 5 times the rotation speed of the substrate “W” (element “R” in FIG. 1). In one aspect, a 300 mm semiconductor substrate is used and is rotated a rotation velocity (element “R”) of about 0.5 rpm to about 50 rpm and the outer diameter of the brushes 13a, 13b are between about 0.5 inches and about 3 inches.

In step 202, the substrate “W” to be cleaned is positioned on the rollers 19a-c between the brushes 13a, 13b. In step 204, the brushes 13a, 13b are moved to a closed position by use of the position actuator assembly 18, sufficiently close to each other so as to both hold the substrate W in place therebetween and exert a force on the substrate surfaces sufficient to achieve effective cleaning of the substrate surface.

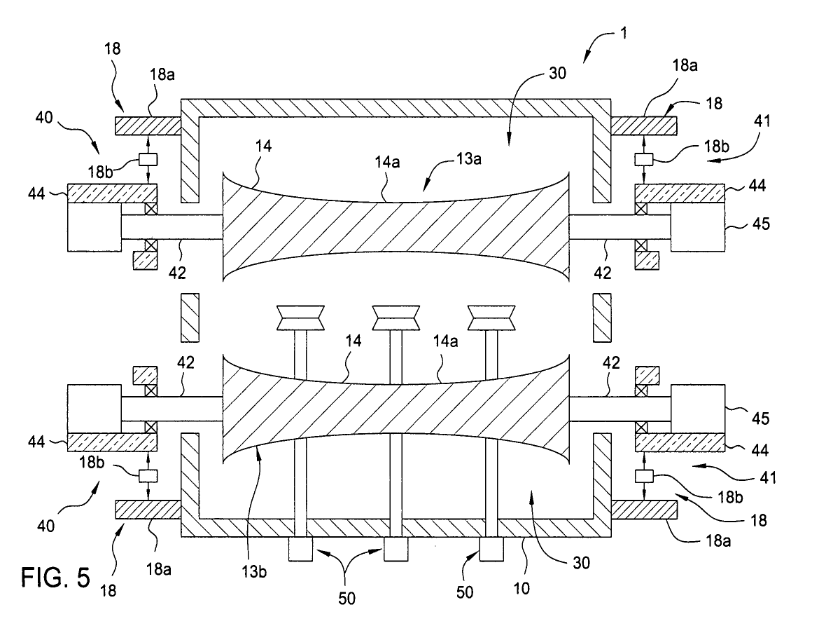

One will note that the amount of material removed from the surface of the substrate is dependent on the amount of force and surface area over which the force is applied as the cleaning medium is urged against the surface of the substrate, the tangential velocity of the brush material against the substrate (related to rotation speed and diameter of the rollers), the brush material, the surface properties of the brush, the surface properties of the substrate surface, and the rotational speed of the substrate imparted by the rollers 19 (element “R” in FIG. 1). It is believed that the removal rate is strongly dependent on the area over which the force is applied to the substrate surface as the cleaning medium is urged against the surface of the substrate. The various embodiments of the invention that deal with the optimized cleaning medium profile are discussed below in FIGS. 5-10.

In step 206, as the brushes 13a, 13b rotate, a cleaning solution is supplied to the substrate W via the spray nozzles 25a-b (FIG. 2) and/or through the brushes 13a, 13b so as to aid in the removal of any residue on the surface of the substrate. In one aspect, during substrate scrubbing, a continuous supply of fresh fluid is sprayed on the substrate W at a controlled rate so as to continuously rinse any residue from the substrate W. The substrate W is cleaned by the frictional and drag forces generated between the rotating brushes 13a, 13b, and by the cleaning/rinsing action of the fluid. In one aspect, the amount of force applied to the surface of the substrate during process step 206 is controlled by use of the position actuator assembly 18 and the controller 101.

In one aspect, cleaning solution is chosen to selectively remove certain materials from the surface of the substrate. In one aspect, it is desirable to choose a chemistry that selectively etches the exposed dielectric materials exposed on the surface of the substrate. In another aspect, it may be desirable to choose a chemistry that preferentially etches certain metals on the substrate surface to assure that any possible contaminant will not become an electrical short in the formed devices or will not diffuse through the dielectric material during subsequent substrate processing steps. In yet another aspect, it may be desirable to non-selectively etch the surface of the substrate to assure that any residual contamination is completely removed from all surfaces of the substrate at the same time. In either case since it may be desirable to remove only a small amount of material from the surface of the substrate, such as about 10 to about 50 Å, a less aggressive chemistry are used to easily control the etch rate and prevent excessive material removal. To achieve this affect it may be desirable to dilute the cleaning chemistry so that the etch rate is low enough so that the removal process is more controllable.

In one aspect, if the substrate W has a copper layer formed on the front-side thereof, the non-etching fluid may comprise a cleaning solution that has about 0.123 wt % of citric acid, 0.016 wt % ammonium hydroxide and deionized water. Other exemplary non-etching solutions are further described in U.S. patent application Ser. No. 09/163,582, filed Sep. 30, 1998, the entire disclosure of which is incorporated herein by this reference, and U.S. patent application Ser. No. 09/359,141 filed Jul. 21, 1999 the entire disclosure of which is incorporated herein by this reference). In another aspect, the non-etching fluid is DI water only.

In another aspect, an etching fluid applied to the substrate W surface(s) which may contain 0.13 wt % citric acid, 0.016 wt % ammonium hydroxide, 0.1 to 0.5 wt % hydrogen peroxide (preferably 0.15%) and deionized water that is further diluted with water in a ratio of about 5:1 to about 100:1 (parts water:parts first solution). In one aspect, other acid solutions may be employed, such as an acid mixed with an oxidant, or an oxidizing acid such as nitric acid (HNO₃) or sulfuric acid (H₂SO₄).

In one aspect, during step 206, the substrate is exposed to a clean process including a cleaning solution that contains a complexing agent to remove oxides, residues and/or contaminates left from a previous fabrication process (e.g., electroless plating, electroplating (ECP), CMP). Contaminants include oxides, copper oxides, copper-organic complexes, silicon oxides, benzotriazole (BTA), resist, polymeric residue, derivatives thereof and combinations thereof. The clean process exposes the surface to the cleaning solution for a period of time of about 5 second to about 120 seconds, preferably from about 10 seconds to about 30 seconds and more preferably at about 20 seconds. The cleaning solution treats the substrate surface and removes contaminates from the exposed conductive material(s), barrier layer materials, and low-k materials. In one embodiment, the cleaning solution is an aqueous solution containing a complexing agent or a surfactant, and at least one acid. In another aspect, a pH adjusting agent and optional additives may be added to the solution containing the complexing agent and the at least one acid. The complexing agent or surfactant may include compounds such as citric acid, EDTA, EDA, carboxylic acids and combinations thereof and derivatives thereof. The acids may include sulfuric acid, hydrochloric acid, hydrofluoric acid, methanesulfonic acid and combinations thereof. The pH adjusting agent may include TMAH, ammonia and other amine based compounds. Polyethylene glycol may be included as an additive to improve the wettability of the complexing agent solution. The composition of a useful cleaning solution is disclosed with more detail in commonly assigned U.S. patent application Ser. No. 11/053,501 [AMAT/8855], entitled, filed on Feb. 8, 2005, which is incorporated by reference herein to the extent not inconsistent with the claimed aspects and description herein.

In one embodiment, a cleaning solution is formed by mixing a first solution that contains citric acid with a concentration in a range from about 0.05 M to about 1.0 M, EDTA with a concentration less than 1 vol %, sulfuric acid with a concentration in a range from about 0.05 N to about 1.0 N or hydrochloric acid with a concentration in a range from about 1 ppb to about 0.5 vol %, and TMAH or ammonia in a concentration to adjust the pH to a range from about 1.5 to about 10.

In another embodiment, a cleaning solution is formed by mixing a first solution that contains citric acid with a concentration in a range from about 0.05 M to about 1.0 M, EDTA with a concentration less than 1 vol %, hydrochloric acid (HCl) with a concentration in a range from about 1 ppb to about 0.5 vol %, and TMAH or ammonia in a concentration to adjust the pH to a range from about 1.5 to about 10.

In another embodiment, a cleaning solution is formed by mixing a first solution that contains citric acid with a concentration in a range from about 0.05 M to about 1.0 M, EDTA with a concentration less than 1 vol %, sulfuric acid with a concentration in a range from about 0.05 N to about 1.0 N, hydrofluoric acid (HF) (49% solution) with a concentration in a range from about 10 ppm to about 2 vol %, and TMAH or ammonia in a concentration to adjust the pH to a range from about 1.5 to about 10. In one aspect, it is desirable to further dilute the cleaning solutions described above with water in a ratio of about 5:1 to about 100:1 (parts water:parts first solution) to improve the material removal process control.

In step 208, after the substrate W is cleaned, the controller 101 opens the brushes 13a, 13b, thereby removing the brushes 13a, 13b from contact with the substrate W. In one aspect, the brushes 13a, 13b may rotate at the same rate whenever the brushes 13a, 13b are in contact with the substrate W.

Cleaning Member Profile

FIG. 5 is a top cross-sectional view of an inventive scrubber device 1 that illustrates one embodiment of the present invention that has a cleaning medium 14 that has a shaped profile to improve the removal rate uniformity across the substrate surface. The term profile of the cleaning medium as used herein is intended to describe the uncompressed shape of the surface, or surfaces, of the cleaning medium 14 that will scrub or abrade the surface of the substrate during the cleaning process. The profile or shape of the cleaning medium surface 14a of the brushes 13a and 13b shown in FIGS. 5 and 7-9 have generally been exaggerated to highlight the various shapes of the cleaning medium 14 that may be useful to perform a uniform cleaning process. In general the shape of the profile of the cleaning medium 14 that may be used to achieve uniform removal rate is dependent on the stiffness of material used, the desired amount of force applied by the position actuator assembly 18 and the mechanical structural aspects of the brush assembly 30 (e.g., thickness) and/or cleaning medium 14 material (e.g., foam, porosity). In the configuration illustrated in FIG. 5 the cleaning medium surface 14a has a concave shaped curved surface which is designed to apply a larger force near the edge of the substrate (not shown) when the cleaning medium 14 is brought into contact with the substrate by use of the position actuator assembly 18. In general the cleaning medium 14 may be made from a material such as polyvinyl alcohol (PVA), Polyurethane (PU), nylon, mohair, or other suitable materials. In general, the cleaning medium can be composed of any material capable of cleaning the surface of a substrate without leaving particles or causing microscopic scratches. In one aspect, the cleaning medium 14 material is formed from a material that is compressible due to the properties of the cleaning medium 14 material (e.g., foam structure, type of material, material hardness) or the structural support used to support or backup the cleaning medium 14.

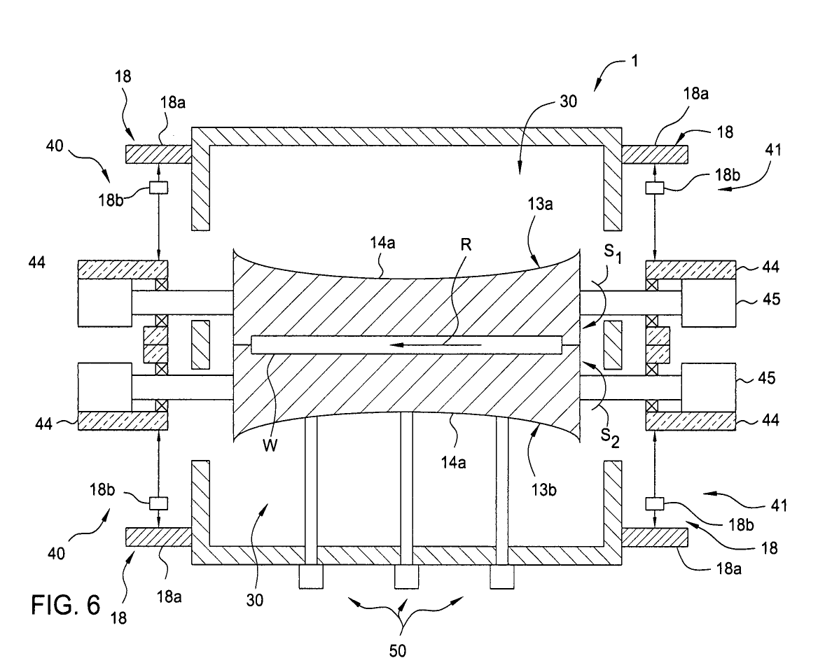

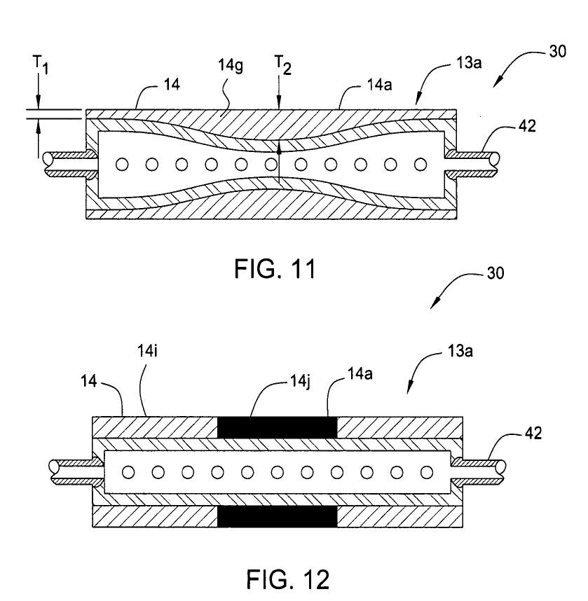

FIG. 6 is a top cross-sectional view of an inventive scrubber device 1, similar to the embodiment shown in FIG. 5, which illustrates a configuration where the brush assemblies 30 are being pressed against the substrate W by use of the position actuator assembly 18. In general the applied force, profile of the cleaning medium 14 and/or stiffness (e.g., hardness, compressive modulus) of the cleaning medium 14 material are selected to assure that during processing all areas of the substrate surface will contact some portion of cleaning medium 14 at some time during the cleaning process. Failure to assure that all areas will contact some portion of the substrate surface will lead to a non-uniform material removal and undesirable process results. In one aspect, it may be desirable to form different regions of the cleaning medium 14 out of different types of material to adjust or tailor the removal rate from the surface of the substrate (see FIG. 11).

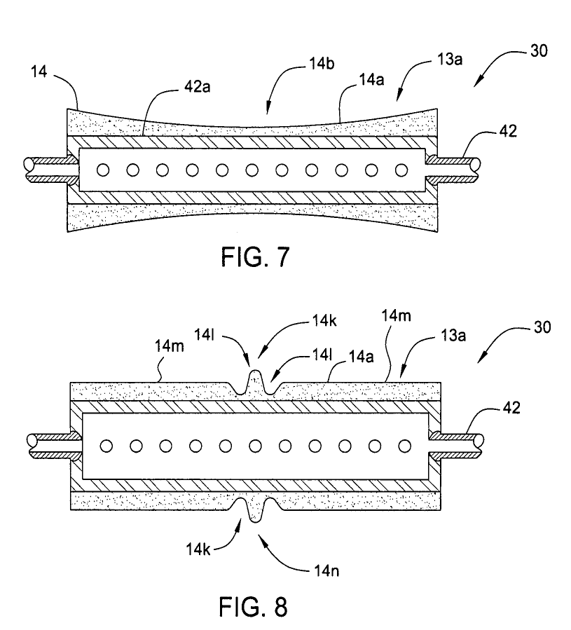

Referring to FIGS. 7-11, in general the cleaning medium surface 14a may be formed or supported in such a way to form a profile that will deliver a uniform material removal rate across the surface of the substrate. By a correct selection of the cleaning medium 14 material, profile of the cleaning medium surface 14a and supporting structure shape the removal rate can be made substantially uniform across the substrate surface. In one embodiment of the invention, it may be desirable to tailor the profile of the cleaning medium 14 to compensate for an increased density of contamination found in certain regions on the processing surfaces of the substrate and thus the material removal rate may not be uniform across the surface of the substrate.

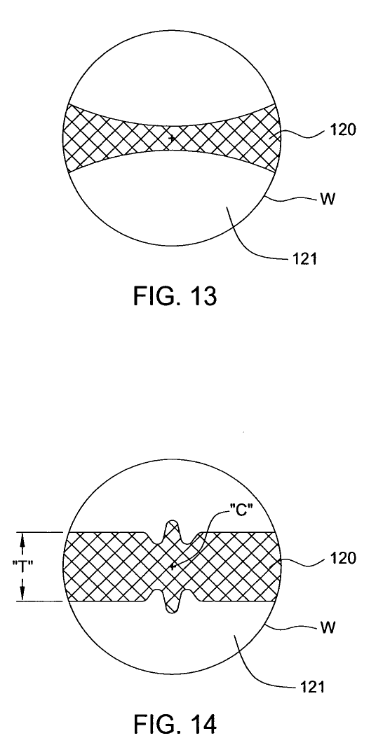

FIG. 7 illustrates a cross-sectional view of one embodiment of the brush assembly 30 in which the profile 14b of the cleaning medium surface 14a is concave in shape. In this configuration the force distribution applied to the surface of the substrate will generally be higher near the edges of the substrate and lower in the middle of the substrate. FIG. 13 illustrates an example of a contact region 120 that is created when a cleaning medium 14 shown in FIG. 7 is urged against the processing surface 121 of the substrate “W” during processing. The shape of the resultant contact region 120, in this case is an hour glass shape, is due to the concave shape of the profile 14b. It should be noted that the force applied within the contact region 120 may not be uniform due to the shape of the cleaning medium 14 and structural support given to the cleaning medium by the cleaning medium support 42a. Therefore, in one embodiment, the material removal rate can also be tailored by adjusting the cleaning medium material properties (e.g., hardness, bulk material density, geometric shape of the cleaning medium in different regions (e.g., stiffness), and modification of the surface properties) to achieve a desired force distribution across the substrate surface. In one embodiment, the shape of the concave shape may be a second degree (e.g., quadratic), third degree (e.g., cubic), exponential, or other shaped curves that delivers a uniform material removal profile across the substrate surface.

FIG. 8 illustrates one embodiment of a cleaning medium surface 14 that has varying profile across the cleaning medium surface 14a. In one embodiment, the cleaning medium surface may have a profile that can be divided into three or more regions. FIG. 8 illustrates a configuration that has three regions (elements 14k-14m). In one aspect, a center region 14k may be a raised region that may be adapted to abrade material from the center of rotation of the substrate surface (element “C” in FIG. 14). The second region 14l, which generally adjacent to the center region, is a characterized by depression in the cleaning medium surface 14 which extends below the center region 14K and the outer region 14m. The third region, or outer region 14m, is generally adjacent to the second region 14l and generally has a flat profile as shown in FIG. 8. In one aspect, as shown in FIG. 8, the center region 14k extends above the outer region 14m. In another aspect, the center region 14k extends above the second region 14l, but does not extend above the outer region 14m. FIG. 14 illustrates one example of one contact region 120 that may be created when a cleaning medium 14 shown in FIG. 8 is urged against the processing surface 121 of the substrate “W” during processing. In one aspect, the rollers 53 and cleaning medium 14 are aligned such that the mid point 14n of the center region 14k of the brush assembly 30 (not shown) contacts the point where the axis of rotation (element “CR” FIGS. 2 and 14) passes through the processing surface of the substrate. The axis of rotation (element “CR”) is created by the rotation (element “R” in FIGS. 1-2) of the substrate by the rollers 53.

Referring to FIG. 8, in one embodiment, the shape of the cleaning medium profile is adapted to apply a force that is proportional to a curve that varies in the shape similar to the following equations:
1/(2πR) 0<R≦T/2 (1)
1/[4R(Sin⁻¹[(T/2)/R])] T/2<R≦R_{w} (2)
Where R is the radius, or measure of the distance from the center of the substrate to a point on the substrate surface, T is the average width of the contact region 120 (FIG. 14) and R_{w} is the radius of the substrate. One will note that T may vary as a function of the applied force, due to the variation in the structural properties (e.g., outer diameter, hardness, stiffness) of the cleaning medium 14 and other brush assembly 30 components.

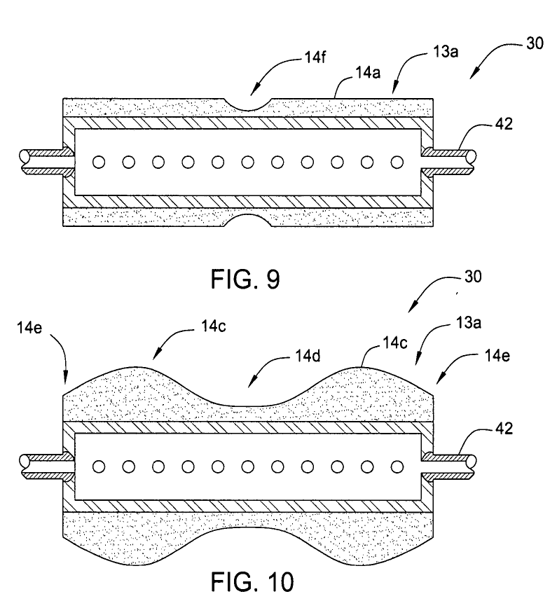

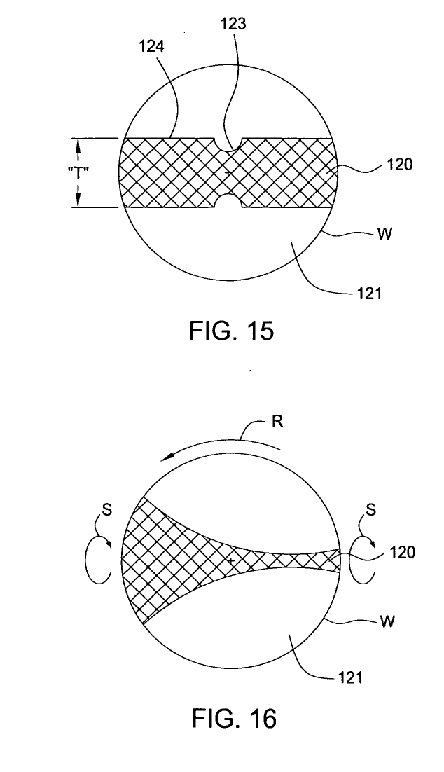

FIG. 9 illustrates a cross-sectional view of one embodiment of the brush assembly 30 in which the profile of the cleaning medium 14 is flat for a most of the length of the cleaning medium surface 14a and has concave region 14f near the center of the substrate. In this configuration the shape of the contacting region 120 will generally has a region that uniform contact shape (element 124), or cleaning medium profile, across most of the substrate surface and then a region of a varying contact shape (element 123) lower in the center region. In one embodiment, the shape of the concave region 14f, and thus contact shape 123, may be a second degree (e.g., quadratic), third degree (e.g., cubic), exponential, or other shaped curves that delivers a uniform material removal profile across the substrate surface. FIG. 15 illustrates one example of one contact region 120 that may be created when a cleaning medium 14 shown in FIG. 9 is urged against the processing surface 121 of the substrate “W” during processing.

FIG. 10 illustrates a cross-sectional view of one embodiment of the brush assembly 30 in which the profile of the cleaning medium surface 14a has two high points 14c and a center depression 14d in the cleaning medium profile. In this configuration the force distribution applied to the surface of the substrate will generally be higher in the regions near the high points 14c and be lower in the regions near the center depression 14d region and edges 14e of the substrate. In this configuration the profile is designed to increase the removal in some internal region of the substrate along the substrate radius.

FIG. 11 illustrates a cross-sectional view of one embodiment of the brush assembly 30 in which the profile of the cleaning medium 14 is flat in shape but the cleaning medium support 42a is formed in a convex shape. To account for the convex shape of the cleaning medium support 42a the thickness of the cleaning medium material 14g is thicker near the center (T₂) and thinner near the edge (T₁) of the cleaning medium support 42a. In this configuration, since the cleaning medium 14 material 14g is generally compressible, the force distribution can be tailored by the thickness of the cleaning medium material 14g. In the configuration shown in FIG. 10 the force distribution applied to the surface of the substrate will generally be higher near the edges of the substrate and lower in the middle of the substrate when the cleaning medium 14 material is more flexible/compressible than the cleaning medium support 42a material.

FIG. 12 illustrates a cross-sectional view of one embodiment of the brush assembly 30 in which the cleaning medium 14 is formed from two or more materials, or from the same material, that have different physical properties in different areas of the cleaning medium 14. Typical materials may include polyvinyl alcohol (PVA), Polyurethane (PU), nylon, mohair, or other suitable materials. In one aspect, as shown in FIG. 11, the profile of the cleaning medium 14 is flat. In other embodiments the surface of the cleaning medium 14 may also have a curved profile to further improve the material removal uniformity. In one aspect, as shown in FIG. 11, the cleaning medium 14 is formed having two regions (elements 14i and 14j) that utilize two different materials that have different properties, such as compressive stiffness and friction coefficient to improve the material removal rate across the surface of the substrate. In one aspect, the surface properties of cleaning medium 14 are modified to adjust the removal rate. Typical modification may include conventional techniques to chemically alter the cleaning medium surface material and heat forming (e.g., “ironing”).

FIG. 16 illustrates one example of one contact region 120 that may be created when a cleaning medium 14 is urged in an uneven pattern against the processing surface 121 of the substrate “W” during processing. In conventional scrubbing processes it is often desirable to assure that the contact force between the cleaning medium 14 and the substrate is higher on the half of the substrate “W” that is rotating (see item R) in the same direction as the cleaning medium 14 is rotating (see item S) to prevent the brush assembly 30 from causing the substrate to slow down or rotate in a direction opposite to the direction the substrate support assemblies 19 are urging the substrate to rotate. In this case it is desirable to adjust the profile of the cleaning medium 14 to provide a higher total force on one side of the substrate while still delivering a uniform material removal rate across the substrate surface. In one aspect, it is desirable to balance the average force to make the material removal rate uniform across the surface of the substrate. FIG. 16 is intended to illustrate a contact region 120 shape that may useful to provide a higher force on one side of the substrate than the other and still deliver a uniform removal rate from the center to the edge of the substrate.

Pressure Sensing

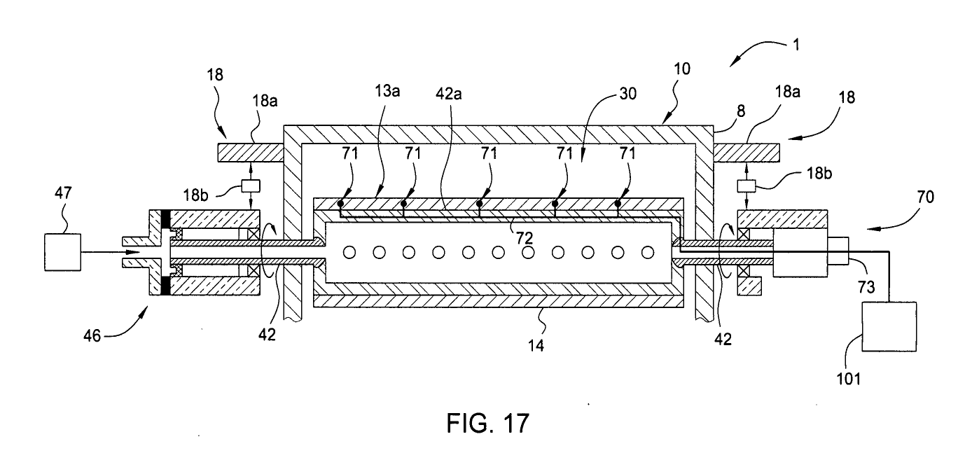

FIG. 17 illustrates a cross-sectional view of one embodiment of the brush assembly that contains a pressure sensing assembly 70 that has a plurality of pressure sensors 71 that are adapted to, in conjunction with the controller 101, sense and control the force applied to the cleaning medium 14 as it is pressed against the surface of the substrate. In general the pressure sensing assembly 70 contains two or more pressure sensors 71 (e.g., strain gauges, piezoelectric sensors), a rotating electric feedthrough 73 (e.g., slip ring, mercury feedthrough) and a controller 101 to sense the signals and adjust the force delivered to the support shaft 42 by the various position actuator assemblies 18 in the scrubbing device 1. The ability to control and adjust the force supplied by the position actuator assemblies 18 is thus used to achieve a uniform material removal from the surface of a substrate. In this configuration the pressure sensors 71 may be distributed across the surface of the cleaning medium 14 so that information can be obtained as to the relative amount of pressure, or force, applied to the surface of the substrate during processing. The collected data can then be used by the controller 101 to adjust and control the removal rate of the material from the surface of the substrate. Electrical connections 72 are configured to connect the various pressure sensors 71 with the rotating electrical feedthrough 73 terminals so that the signal(s) from the sensor can be transferred to the controller 101. This configuration thus allows feedback as to the forces being applied to the surface of the substrate which allows the controller 101 to vary the force delivered by each of the actuators 18b to assure that the removal rate is uniform across the surface of the substrate. In one embodiment, it may be desirable to add a plurality of force creating devices, for example inflatable bladders, that are adapted to deliver an adjustable amount of force to different regions of the substrate surface through different regions of the cleaning medium 14 during processing.

In one aspect, it may be desirable to separately vary the amount of fluid delivered to one or more of the plurality of holes 42b formed in the cleaning medium support 42a on which the cleaning medium 14 is placed (FIG. 3A), based on the pressure sensed by the various pressure sensors 71. In this configuration, the a varying pressure can be supplied by the cleaning medium 14 to the substrate surface, by a varying viscous drag force created by the varying flow of the fluid through the holes 42b and pores formed of the cleaning medium 14.

Cleaning Medium Surface Features

In one embodiment, a surface pattern is formed on the cleaning medium surface 14a to improve the removal of the material from the surface of the substrate. In one aspect the surface pattern may be a regular array of protrusions, depressions or flat regions that are adapted to help remove material from the surface of the substrate. In one aspect, the array of protrusions, depressions and/or flat regions may be between about 10 μm to about 1 mm in size.

While the foregoing is directed to embodiments of the present invention, other and further embodiments of the invention may be devised without departing from the basic scope thereof, and the scope thereof is determined by the claims that follow.

1. A substrate cleaning chamber that is adapted to clean a surface of a substrate, comprising:
a roller that is adapted to rotate a substrate, wherein an axis of rotation of the substrate is generally perpendicular to a processing surface of the substrate;
a cleaning medium having a surface that has a non-uniform profile, wherein the cleaning medium is adapted to provide a non-uniform force to a contact region formed on the processing surface of the substrate; and
a motor that is adapted to rotate the cleaning medium, wherein the axis of rotation of the cleaning medium is generally perpendicular to the axis of rotation of the substrate.

2. The substrate cleaning chamber of claim 1, wherein the non-uniform profile has a region on the cleaning medium surface that is concave in shape.

3. The substrate cleaning chamber of claim 1, wherein the cleaning medium material is selected from a group consisting of polyvinyl alcohol, polyurethane, nylon, and mohair.

4. The substrate cleaning chamber of claim 1, wherein the non-uniform profile comprises:
a mid-region on the cleaning medium surface;
a center region on the cleaning medium surface that protrudes above the mid-region and is adjacent to the mid-region, wherein the center region contacts a point on the processing surface through which the axis of rotation of the substrate passes; and
an edge region on the cleaning medium surface that protrudes above the mid-region and extends from the edge of the processing surface of the substrate to the edge of the mid-region.

5. The substrate cleaning chamber of claim 1, further comprising a second cleaning medium having a surface that is adapted to contact a non-processing surface of the substrate.

6. The substrate cleaning chamber of claim 1, further comprising a first nozzle that is adapted to deliver a fluid to the processing surface of the substrate, wherein the amount of fluid delivered to the processing surface is non-uniform.

7. A substrate cleaning chamber that is adapted to clean a surface of a substrate, comprising:
a roller that is adapted to rotate a substrate, wherein an axis of rotation of the substrate is generally perpendicular to a processing surface of the substrate positioned on the roller;
a cleaning medium assembly that is adapted to remove material from the processing surface of a substrate, wherein the cleaning medium comprises:
a first cleaning medium that is adapted to clean a portion of the processing surface of a substrate; and
a second cleaning medium that is adapted to clean a portion of the processing surface of a substrate, wherein the first cleaning medium has a different material property than the second cleaning medium; and
a motor that is adapted to rotate the cleaning medium, wherein the axis of rotation of the cleaning medium is generally perpendicular to the axis of rotation of the substrate.

8. The substrate cleaning chamber of claim 7, wherein the material property is selected from a group consisting of surface hardness, coefficient of friction, or bulk material density.

9. The substrate cleaning chamber of claim 7, wherein the material from which the first cleaning medium and the second cleaning medium are made is selected from a group consisting of polyvinyl alcohol, polyurethane, nylon, and mohair.

10. The substrate cleaning chamber of claim 7, wherein the cleaning medium assembly has a non-uniform profile that delivers a non-uniform contact force.

11. A substrate cleaning chamber that is adapted to clean a surface of a substrate, comprising:
a roller that is adapted to rotate a substrate, wherein an axis of rotation of the substrate is generally perpendicular to a processing surface of the substrate positioned on the roller;
a cleaning medium that has a uniform profile, wherein the cleaning medium is adapted to deliver a uniform material removal rate across the surface of the substrate due to a non-uniform cleaning medium material thickness across the contact region; and
a motor that is adapted to rotate the cleaning medium, wherein the axis of rotation of the cleaning medium is generally perpendicular to the axis of rotation of the substrate.

12. The substrate cleaning chamber of claim 11, wherein the non-uniform cleaning medium material thickness is thicker near the center of the substrate versus the edge of the substrate.

13. A substrate cleaning chamber that is adapted to clean a surface of a substrate, comprising:
a roller that is adapted to rotate a substrate, wherein an axis of rotation of the substrate is generally perpendicular to a processing surface of the substrate positioned on the roller;
a brush assembly comprising:
a cleaning medium having a surface that has a non-uniform profile, wherein the cleaning medium is adapted to provide a non-uniform force along the radius of the processing surface of the substrate; and
two or more sensors that are coupled to the cleaning medium and are adapted to sense the force applied in different regions of the processing surface of the substrate by the cleaning medium; and
a motor that is adapted to rotate the cleaning medium, wherein the axis of rotation of the cleaning medium is generally perpendicular to the axis of rotation of the substrate;
an actuator coupled to the brush assembly that is adapted to supply a adjustable force to urge the cleaning medium against the processing surface of the substrate; and
a controller adapted to control the force supplied to the cleaning medium by actuator based on input received from the two or more sensors.

14. The substrate cleaning chamber of claim 13, wherein the material property is selected from a group consisting of hardness, coefficient of friction, and bulk material density.

15. The substrate cleaning chamber of claim 13, wherein the cleaning medium is selected from a group consisting of polyvinyl alcohol, polyurethane, nylon, and mohair.

16. A method of cleaning a processing surface of a substrate, comprising:
rotating a substrate at a first rotational speed about an axis that is generally perpendicular to a processing surface of the substrate;
rotating a cleaning medium that has a non-uniform surface profile at a second rotational speed about an axis that is generally perpendicular to the axis of rotation of the substrate; and
urging the cleaning medium having a non-uniform profile against the processing surface of a substrate by use of an actuator, wherein the cleaning medium is adapted to provide a non-uniform force along the radius of the processing surface of the substrate.

17. The method of claim 16, wherein the second rotational speed is about 3 to about 5 times faster than the first rotational speed.

18. A method of cleaning a processing surface of a substrate, comprising:
rotating a substrate at a first rotational speed about an axis that is generally perpendicular to a processing surface of the substrate;
rotating a cleaning medium that has a non-uniform surface profile at a second rotational speed about an axis that is generally perpendicular to the axis of rotation of the substrate, wherein non-uniform surface profile of the cleaning medium has a central region and an edge region;
positioning the substrate so that a point on the processing surface of the substrate through which the axis of rotation passes contacts a point in the central region of the non-uniform profile; and
urging the cleaning medium having a non-uniform profile against the processing surface of a substrate by use of an actuator, wherein the cleaning medium is adapted to provide a non-uniform force along the radius of the processing surface of the substrate.

19. The method of claim 18, wherein the second rotational speed is about 3 to about 5 times faster than the first rotational speed.

20. A method of cleaning a processing surface of a substrate, comprising:
rotating a substrate at a first rotational speed about an axis that is generally perpendicular to a processing surface of the substrate;
rotating a cleaning medium that has a non-uniform surface profile at a second rotational speed about an axis that is generally perpendicular to the axis of rotation of the substrate;
urging the cleaning medium having a non-uniform profile against the processing surface of a substrate by use of an actuator, wherein the actuator and cleaning medium are adapted to provide a non-uniform force along the radius of the processing surface of the substrate;
measuring the force applied to the processing surface of the substrate by the cleaning medium by use of a plurality of sensors coupled to the cleaning medium; and
collecting the measured force from the plurality of sensors and adjusting the force delivered to the processing surface by the cleaning medium by use of a controller that is adapted to control the force supplied by the actuator.
